(19) United States
(12) Patent Application Publication
(10) Pub. No.: US 2008/0247188 A1
(43) Pub. Date: Oct. 9, 2008

(54) Complex projector lens for LED headlamp

(75) Inventor: Ronald Owen Woodward, Yorktown, VA (US)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/732,557

(22) Filed: Apr. 4, 2007

(51) Int. Cl. G02B 6/04; G02B 6/00; F21V 5/00

(52) U.S. Cl. 362/554; 362/551; 362/326

(57) ABSTRACT

The present invention is a lighting arrangement having at least one light source, light at least two light pipes for receiving light from the light source, and a lens having two or more sections. The lens is configured to receive light from at least one of the at least two light pipes, wherein each one of the sections projects light in a desired isomeric beam pattern.

### FIELD OF THE INVENTION

The present invention relates to lenses used in conjunction with LED lights to produce a desired beam pattern.

### BACKGROUND OF THE INVENTION

Typical projector lamps incorporate a reflector and a light shield. The reflector creates a smooth distribution of light that is imaged by an aspheric convex lens onto the road. Projector lamps can also be used along with light emitting diodes (LED) to provide light that is distributed through light guides, typically in the form of fiberoptic cables, and deflected through the lens. The LEDs can provide a uniform light, points of light, or be surrounded by dark areas. If a normal lens is used along with the LEDs, the resulting beam pattern will exhibit any present dark patches. Additionally, performing additional functions of the projector lamp, such as high-beam and low-beam functions, also requires controlling the light from a second array of LEDs, so that they combine with the distribution of the original set of LEDs to produce a head lamp beam pattern. Additional LEDs may be illuminated to create a high beam or fog lamp functions. Other LEDs may be used to produce light bending functions to aid in seeing around corners. Simply imaging these arrays would not create a beam pattern that can meet the required optical performance. Applying a second standard spreader lens to be used with the LEDs could achieve the required blending; however, it would increase the number of parts, and decrease the system performance by introducing additional fresnel losses into the optical system. Adding additional optical elements between the projector lens and the luminous patches would likewise add additional parts and decrease system performance.

Accordingly there exists a need for a lens which can be used with two or more sets of LEDs to produce various types of beam patterns.

### SUMMARY OF THE INVENTION

The present invention is a lighting arrangement having at least one light source, light at least two light pipes for receiving light from the light source, and a lens having two or more sections. The lens is configured to receive light from at least one of the at least two light pipes, wherein each one of the sections projects light in a desired isomeric beam pattern.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a lens and a light pipe bundle, according to the present invention;

FIG. 2 is a front view of a major group of light pipes, a minor group of light pipes, and an auxiliary group of light pipes, according to the present invention;

FIG. 3 is a front view of a lens divided into horizontal segments, according to the present invention;

FIG. 4 is a graph depicting a group of isocurves used for producing a high-beam pattern and a low-beam pattern, produced by a lens, according to the present invention;

FIG. 5 is a graph of a first group of isocurves, along with a first source isocurve, produced by a lens, according to the present invention;

FIG. 6 is a graph of a second group of isocurves, along with a second source isocurve, produced by a lens, according to the present invention;

FIG. 7 is a side view of a graph depicting a lens moved along a vertical plane to create one of the segments shown in FIG. 3, according to the present invention;

FIG. 8 is a lens according to the present invention, taken along lines 8-8 of FIG. 7,

FIG. 9 is a perspective view of a lens and mounting assembly, according to the present invention;

FIG. 10 is an alternate embodiment of a major group of light pipes and a minor group of light pipes, according to the present invention;

FIG. 11 is a front view of an alternate embodiment of a major group of light pipes, a minor group of light pipes, and an auxiliary group of light pipe, according to the present invention; and

FIG. 12 is a perspective view of an alternate embodiment of a lens, according to the present invention.

### DETAILED DESCRIPTION OF THE PREFERRED EMBODIMENTS

The following description of the preferred embodiment(s) is merely exemplary in nature and is in no way intended to limit the invention, its application, or uses.

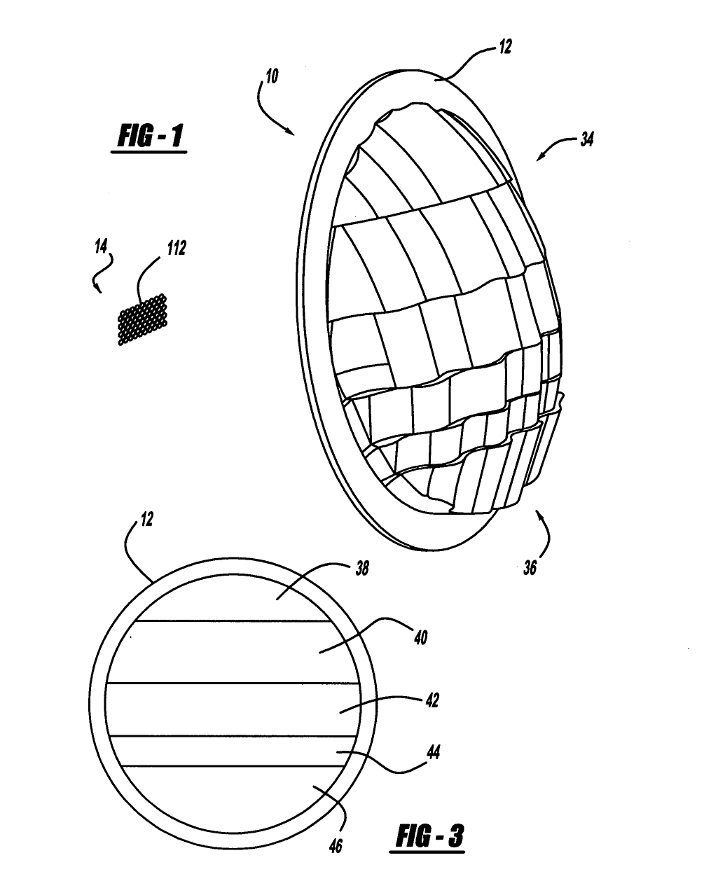

Several components of a lighting arrangement according to the present invention are shown generally in FIG. 1 at 10. The lighting arrangement 10 includes a lens 12 and a light pipe bundle 14. The light pipe bundle 14 is used for directing light toward the lens 12 from a light source (not shown). FIG. 2 shows a front view of the light pipe bundle 14, in this view, the light is being directed from the light source through the light pipe bundle 14 out of the page. The light pipe bundle 14 includes at least one light pipe, and more preferably includes a group of major light pipes 16 receiving light from a first light source, a group of minor light pipes 18 receiving light from a second light source, and a group of auxiliary light pipes 20. The light pipes 16, 18, 20 of the present invention could be fiber optic cables, or could also be a combination of an LED (Light Emitting Diode) or group of LED's with closely coupled optics. The light pipes 16, 18, 20 of the present invention could also be LED's with direct imaging.

In this embodiment the auxiliary light pipes 20 are divided into a group of first auxiliary light pipes 22, a group of second auxiliary light pipes 24, a group of third auxiliary light pipes 26, a group of fourth auxiliary light pipes 28, a group of fifth auxiliary light pipes 30, and a group of sixth auxiliary light pipes 32. The major light pipes 16, minor light pipes 18, and auxiliary light pipes 20 can be used to perform various lighting functions, such as producing a high-beam, a low-beam, or a turn signal in an automobile. More specifically, the major light pipes 16 can be used to produce a wide beam pattern, and the group of minor light pipes 18 can be used to produce a “hot spot” beam, where an area of light is intensified. The auxiliary light pipes 20 can be used to produce a light bending function, as well as additional hot spot beam patterns.

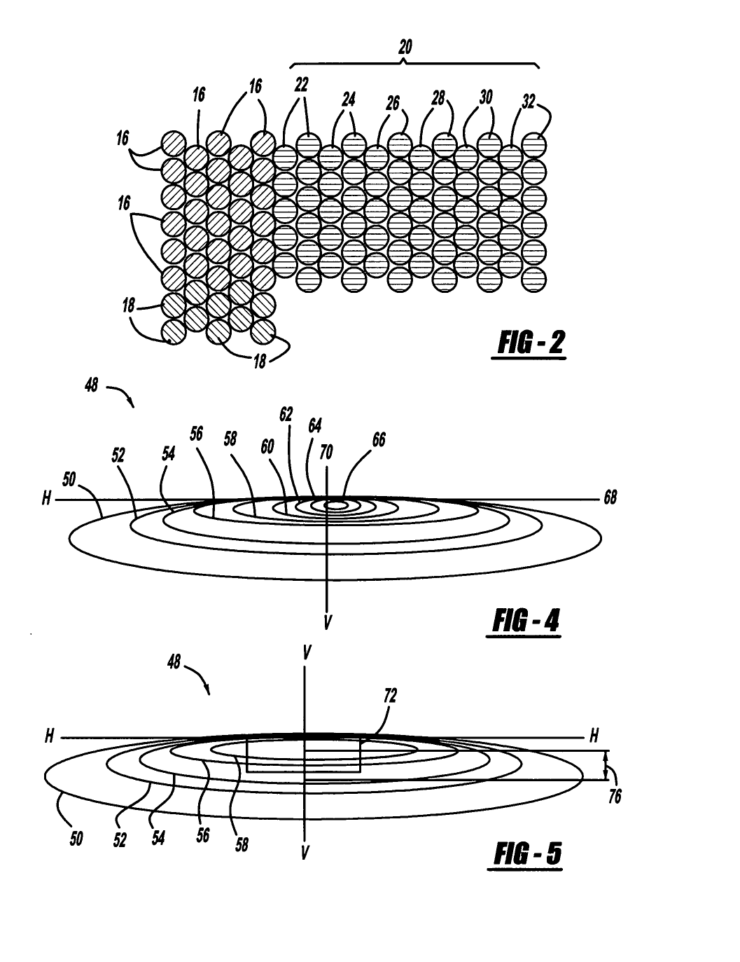

Referring back to FIG. 1, the lens 12 is divided into various horizontal sections, shown generally at 34 and vertical sections, shown generally at 36. The shape of the horizontal sections 34 and the vertical sections 36 depends on the desired light beam pattern. Referring to FIGS. 4-6, an example of a desired beam pattern is generally shown at 48. The desired beam pattern 48 is divided into several isocurves. The beam pattern 48 may have as many isocurves as needed to produce the desired beam pattern 48 with the desired hotspot. In this embodiment, a portion of the beam pattern 48 is made up a first group of isocurves produced by the major light pipes 16 shown as the first isocurve 50, second isocurve 52, third isocurve 54, fourth isocurve 56, and fifth isocurve 58. The remaining portion of the beam pattern 48 is made up of a second group of isocurves produced by the minor light pipes 18 shown as sixth isocurve 60, a seventh isocurve 62, an eighth isocurve 64, and a ninth isocurve 66.

The isocurves 50, 52, 54, 56, 58, 60, 62, 64, 66 are shown in FIGS. 4-6 on a horizontal axis 68 and a vertical axis 70, and represent the area that the desired beam pattern 48 will illuminate. Each isocurve 50, 52, 54, 56, 58, 60, 62, 64, 66 is of a different intensity and illuminates a different area of the desired beam pattern 48.

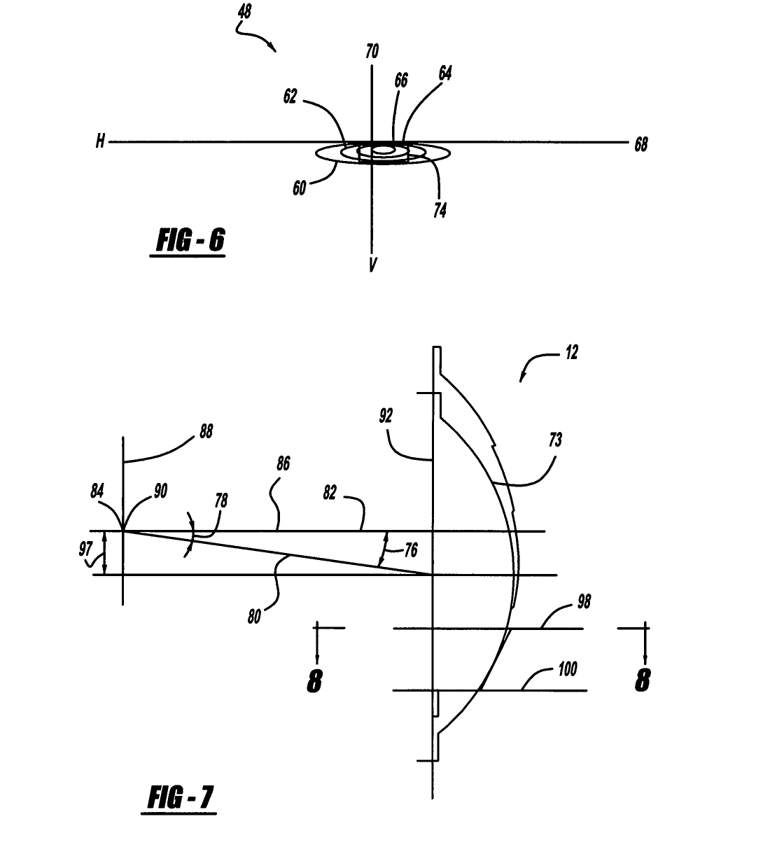

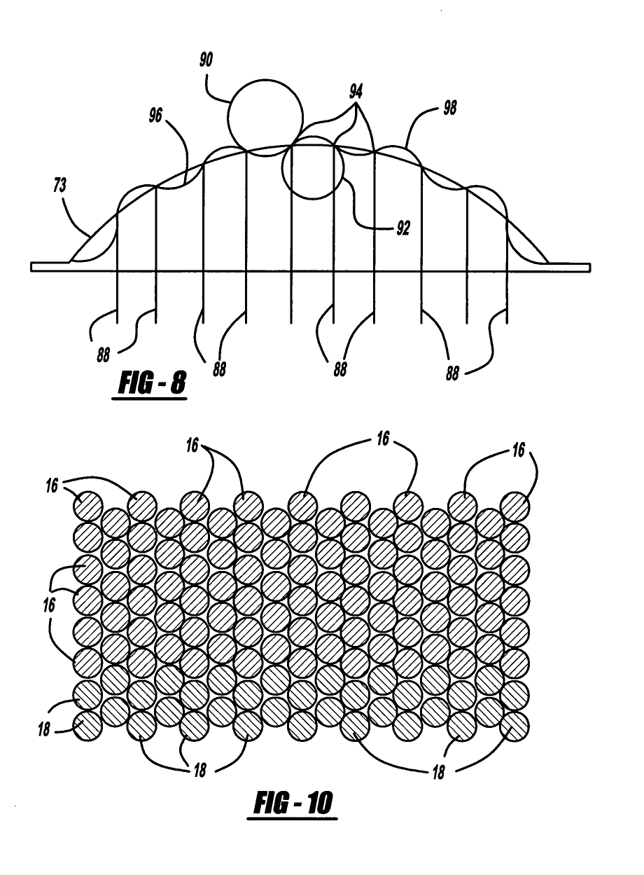

The first set of isocurves 50, 52, 54, 56, 58 are shown in FIG. 5. Also shown in FIG. 5 is a typical first source isocurve 72. The first source isocurve 72 is the type of isocurve produced when the major light pipes 16 are used along with a simple aspheric projector lens, for example the base lens 73 shown in FIG. 7, having the appropriate focal length, and not the modified lens 12 of the present invention. The focal length chosen must be no shorter than one that will produce an image with a height that is no more than twice the distance from the center of the smallest zone to be illuminated and the horizontal axis 68. Images that are larger cannot be blended to produce the desired vertical image size and will result in patterns taller than desired.

The second set of isocurves 60, 62, 64, 66 are shown in FIG. 6, along with a typical second source isocurve 74. The second source isocurve 74 is the type of isocurve produced when the minor light pipes 18 are used along with a simple aspheric projector lens, such as the base lens 73 shown in FIG. 7, having the appropriate focal length, and not the modified lens 12 of the present invention. The focal length chosen must be no shorter than one that will produce an image with a height that is no more than twice the distance from the center of the smallest zone to be illuminated and the horizontal axis 68. Images that are larger cannot be blended to produce the desired vertical image size and will result in patterns taller than desired.

In order to have the major light pipes 16 produce isocurves 50, 52, 54, 56, 58 when used with the lens 12 of the present invention, instead of first source isocurve 72 when the major light pipes 16 are used with the base lens 73, and for minor light pipes 18 to produce isocurves 60, 62, 64, 66 when used with the lens 12 of the present invention, instead of second source isocurve 74 when the minor light pipes 18 are used with the base lens 73, the following steps for producing the shape of the lens 12 of the present invention will now be described.

The first step in defining the shape of the lens 12 is to determine the lumen content (amount of luminous flux) of the portion of the desired beam pattern 48 produced by isocurves 50, 52, 54, 56, 58 by integrating the intensity of isocurves 50, 52, 54, 56, 58 over the angular area covered by the isocurves 50, 52, 54, 56, 58. The lumen output produced by the major light pipes 16 and controlled by the lens 12 is determined by integrating the intensity defined in the first source isocurve 72 (produced by the major light pipes 16 when projected through the aspheric projector lens described above) over the angular area covered by the first source isocurve 72.

The lumen content of the portion of the desired beam pattern 48 produced by isocurves 50, 52, 54, 56, 58 and the lumen content produced by the major light pipes 16 to create the first source isocurve 72 must be nearly equal. The reason for this is that the lens 12 of the present invention is using the light produced by the major light pipes 16, which produce the first source isocurve 72 when used with the base lens 73, to produce the portion of the beam pattern 48 made up of isocurves 50, 52, 54, 56, 58 by projecting the light from the major light pipes 16 through the lens 12 of the present invention. If the lumen contents are not equal, then light intensity or area coming from the major light pipes 16 must be increased, or the desired light intensity defined by isocurves 60, 62, 64, 66 must be reduced by sacrificing performance (or the amount of light required) between the isocurves 50, 52, 54, 56, 58 and the isocurves 60, 62, 64, 66 and rebalancing the system by adjusting the location and/or intensity of the fifth isocurve 58 and sixth isocurve 60. Once the balance of available vs. desired lumen contact is achieved for isocurves 50, 52, 54, 56, 58 and isocurves 60, 62, 64, 66 the detailed shape of the surface of the lens 12 can be defined.

Referring back to FIG. 3, one of the steps for producing the shape of the lens 12 is achieved by taking the base lens 73, and dividing the base lens 73 into horizontal segments 38, 40, 42, 44, 46. The size of each horizontal segment 38, 40, 42, 44, 46 is selected such that each segment controls the same amount of lumen content required by an associated isocurve. The amount of lumen content of each of the isocurves 50, 52, 54, 56, 58, 60, 62, 64, 66 is determined by a process of looking at each of the isocurves 50, 52, 54, 56, 58, 60, 62, 64, 66 individually taken as a separate component of the beam pattern 48.

Beginning with the isocurve having the lowest intensity, the first isocurve 50, the lumen content is calculated by integrating over the isocurve's 50 area, assuming the entire area is of uniform intensity. The average light intensity of the area of the first isocurve 50 is then subtracted from the area of all the other isocurves 52, 54, 56, 58, 60, 62, 64, 66. The lumen content of the isocurve having the next lowest intensity, in this embodiment the second isocurve 52, is then calculated using the same steps used to calculate the lumen content of the first isocurve 50. This process continues until the lumen content of each isocurve 50, 52, 54, 56, 58, 60, 62, 64, 66 is determined. Once the lumen content of each of the isocurves 50, 52, 54, 56, 58, 60, 62, 64, 66 is determined, then size of each of the segments 38, 40, 42, 44, 46 can then be determined. The process for determining the size of each of the segments 38, 40, 42, 44, 46 is repeated until the lens area required to control the lumen content of each of the isocurves 50, 52, 54, 56, 58, 60, 62, 64, 66 is attained.

To create each of the segments 38, 40, 42, 44, 46 the following steps are taken. Referring to FIGS. 3 and 7, and beginning with fifth horizontal segment 46, and the first isocurve 50, the angular distance, indicated generally at 76, is determined by calculating the angular distance between the center of the first isocurve 50, and the center of the source isocurve 72 in FIG. 5. This forms an angle 78 having a first ray 80 and a second ray 82 which intersect at a vertex 84. The base lens 73 also includes an axis 86 and a focal plane 88 which intersect perpendicularly to form a first intersection point 90. The base lens 73 also has a rear plane 92 which intersects perpendicularly with the axis 86. The angle 78 is positioned such that the vertex 84 is aligned with the first intersection point 90, and one of the rays, in this embodiment the second ray 82, is aligned with the axis 86. When in this position, the first ray 80 intersects the rear plane 92 to form a second intersection point 94, and the second ray 82 intersects the rear plane 92 to form a third intersection point 96. The base lens 73 is shifted the distance between the second intersection point 94 and the third intersection point 96, shown as a vertical distance 97. An upper boundary 98 and lower boundary 100 are chosen and are dependent upon the area to be covered by each isocurve. The portion of the base lens 73 located between the upper boundary 98 and lower boundary 100 after the lens 73 is shifted forms the fifth horizontal segment 46, which forms a portion of the shape of the lens 12.

Once the segment 46 is created, the segment 46 is further divided into multiple horizontal subsegments, generally shown at 102 in FIG. 8. Depending on the size of the subsegments 102, the distance between the source isocurve 72 and the desired spread of the isocurve 50, a concave radius of curvature 104 and a convex radius of curvature 106 can be calculated to allow the light from the isocurve 50 to be deflected over the desired angle. The concave radius of curvature 104 must be larger than the convex radius of curvature 106 due to the divergent characteristics of the light emitted from the major light pipes 16. The concave radius of curvature 104 and convex radius of curvature 106 are positioned in alternating fashion to form the lens 12, and the concave radius of curvature 104 connects to the convex radius of curvature 106 at interconnection points 108 between each of the concave radius of curvatures 104, the convex radius of curvatures 106, and the subsegments 102. Note that only a portion of the concave radius of curvature 104, shown as a concave arc 110, and a portion of the convex radius of curvature 106, shown as an arc 112 are used to form the lens 12.

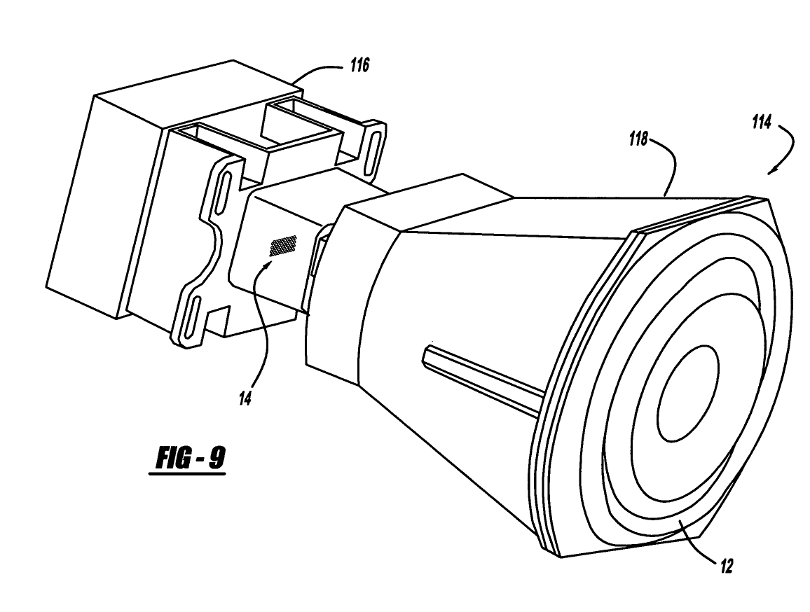

Once the fifth segment 46 is formed, the process described above is repeated for each isocurve and each segment, until the lens 12 shown in FIG. 1 is complete. Once the lens 12 is complete, the lens 12 can be installed onto a lamp assembly 114 as shown in FIG. 9. The lamp assembly 114 has a base 116, and a support member 118 for supporting the lens 12.

The present invention is not limited to the embodiments previously described. Instead of having major light pipes 16, minor light pipes 18, and auxiliary light pipes 20, the present invention can also simply have major light pipes 16 and minor light pipes 18, and the various light pipes can be arranged in different ways. The major light pipes 16 can be arranged above the minor light pipes 18, as shown in FIG. 10. Also, the major light pipes 16, minor light pipes 18, and auxiliary light pipes 20 can be packed tightly together to form a lighted segment, as shown in FIGS. 2 and 10, or each of the major light pipes 16, minor light pipes 18, and auxiliary light pipes 20 can be a single large pixel, as shown in FIG. 11.

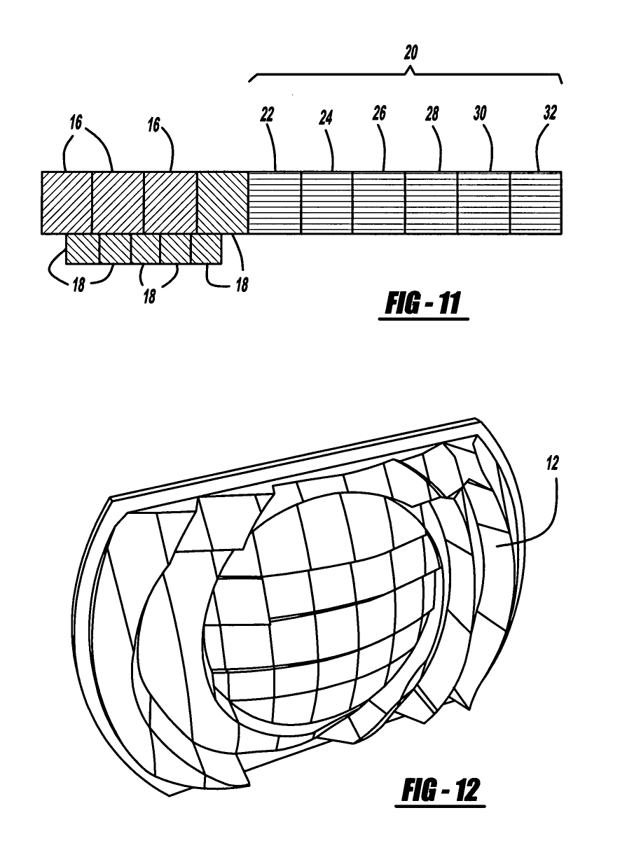

It should also be noted that the process for defining the shape of the lens 12 of the present invention is not limited to the lenses described above. The process can also be applied to a lens of Fresnel type optics as shown in FIG. 12 if a reduced maximum thickness is required.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A lighting arrangement, comprising:
at least one light source;
at least two light pipes for receiving light from said at least one light source;
a lens having two or more sections, each configured to receive light from at least one of said at least two light pipes, wherein each one of said two or more sections projects light in a desired isomeric beam pattern.

2. The lighting arrangement of claim 1, said at least two light pipes further comprise a light pipe bundle.

3. The lighting arrangement of claim 2, wherein said light pipe bundle further comprises:
a group of major light pipes;
a group of minor light pipes; and
a group of auxiliary light pipes.

4. The lighting arrangement of claim 1, wherein one of said two or more sections of said lens produces a wide beam pattern.

5. The lighting arrangement of claim 1, wherein one of said two or more sections of said lens produces a hot spot beam pattern.

6. The lighting arrangement of claim 1, wherein light emitted from one of said at least two light pipes through said plurality of sections produces a first group of isocurves, and light emitted from one of said at least two light pipes through said plurality of sections produces a second group of isocurves.

7. The lighting arrangement of claim 6, said first group of isocurves produces a wide beam pattern, and said second group of isocurves produces a hot spot beam pattern.

8. The lighting arrangement of claim 6, the shape of each of said plurality of sections of said lens is defined by a plurality of horizontal sections, and a plurality of vertical sections.

9. A method for directing light from a light source, the method comprising the steps of:
providing at least one light source;
providing a lens having a plurality of sections;
providing at least two light pipes;
providing a desired beam pattern;
directing light from said at least one light source through said lens having a plurality of sections through one of said at least two light pipes
dividing said desired beam pattern into a plurality of isocurves;
determining the lumen content of each of said plurality of isocurves;
producing at least one source isocurve with said at least one light source;
providing a focal plane, a rear plane, and an axis for a base lens;
forming a first intersection point by intersecting said focal plane and said axis of said base lens;
determining the angular distance between the center of said at least one source isocurve and each of said plurality of isocurves, said angular distance forming a plurality of angles having a vertex, a first ray, and a second ray;
aligning said vertex of each of said plurality of angles substantially with said first intersection point;
aligning one of either said first ray or said second ray with said axis of said base lens, causing one of said first ray or said second ray to intersect said rear plane of said base lens to form a second intersection point, and one of said first ray or said second ray to intersect said rear plane of said base lens to form a third intersection point;
shifting said base lens the distance between said second intersection point and said third intersection point formed by each of said plurality of angles;
dividing said lens into a plurality of horizontal segments after said base lens has been shifted; and
selecting the size of each horizontal segment to control the same amount of lumen content of said plurality of isocurves.

10. The method of claim 9, further comprising the steps of:
producing a beam pattern by directing light from said light source through said lens with one of said at least two light pipes.

11. The method of claim 9, further comprising the steps of;
selecting one of said plurality of horizontal segments, and dividing said one of said plurality of horizontal segments into horizontal subsegments;
calculating the size of a plurality of concave radius of curvatures and a plurality of convex radius of curvatures to deflect light through said horizontal subsegments to form said plurality of isocurves;
connecting said plurality of concave radius of curvatures and said convex radius of curvatures in alternating fashion to form a series of concave arcs and convex arcs connected together in alternating fashion; and
said series of convex arcs and concave arcs form said horizontal subsegment, and said subsegment forms one of said plurality of segments of said lens having a plurality of segments.

12. The method of claim 11, further comprising the step of creating said concave radius of curvature to be larger than said convex radius of curvature.

13. The method of claim 9, further comprising the steps of:
producing a wide beam pattern by selecting one of said at least two light pipes to direct light through said lens having a plurality of segments; and
producing a hot spot beam pattern by selecting one of said at least two light pipes to direct light through said lens having a plurality of segments.

14. A method for producing beams patterns by directing light through a lens, comprising the steps of:
providing a first group of light pipes;
providing a second group of light pipes;
providing a lens having a plurality of sections;
providing a wide beam pattern by directing light from at least one light source through said lens having a plurality of sections using said first group of light pipes; and
providing a hot spot beam pattern by directing light from said at least one light source through said lens having a plurality of sections using said second group of light pipes.

15. The method of claim 14, further comprising the steps of:
providing at least one auxiliary light pipe; and
producing a light bending function by directing light from said at least one light source through said lens having a plurality of sections by using said at least one auxiliary light pipe.

16. The method of claim 14, further comprising the steps of:
providing at least one auxiliary light pipe; and
producing a hot spot beam pattern by directing light from said at least one light source through said lens having a plurality of sections by using said at least one auxiliary light pipe.

17. The method of claim 14, further comprising the steps of:
providing said wide beam pattern to be comprised of a first group of isocurves;
providing said hot spot beam pattern to be comprised of a second group of isocurves; and
providing a desired beam pattern made up of either or both of said wide beam pattern and said hot spot beam pattern.

18. The method of claim 17, further comprising the steps of:
determining the lumen content of each of said first group of isocurves;
determining the lumen content of each of said second group of isocurves;
providing a first source isocurve created by directing light from said at least one light source through an aspheric lens using said first group of light pipes;
providing a second source isocurve created by directing light from said at least one light source through said aspheric lens using said second group of light pipes;
determining the amount of lumen content produced by said first source isocurve; and
determining the amount of lumen content produced by said second source isocurve.

19. The method of claim 18, further comprising the steps of:
determining the angular distance between the center of each of said first group of isocurves and the center of said first source isocurve, creating a first group of angles, each of said first group of angles having a vertex, a first ray, and a second ray;
determining the angular distance between the center of each of said second group of isocurves and the center of said second source isocurve, creating a second group of angles, each of said second group of angles having a vertex, a first ray, and a second ray;
providing said aspheric lens with an axis and a focal plane, said axis being perpendicular to said focal plane;
providing a first intersection point between said axis of said aspheric lens and said focal plane of said aspheric lens;
determining a vertical distance along the rear surface of said aspheric lens created by positioning said vertex of each of said first group of angles and said second group of angles substantially at said intersection point, aligning one of either said first ray or said second ray of each of said first group of angles and said second group of angles with said axis;
intersecting said rear surface of said aspheric lens with said first ray of each of said first group of angles and said second group of angles to create a series of second intersection points, and intersecting said rear surface of said aspheric lens with said second ray of said first group of angles and said second group of angles to create a series of corresponding third intersection points;
displacing said aspheric lens the distance between said series of second intersection points and said corresponding third intersection points, and forming at least one segment for directing light emitted from said first group of light pipes and said second group of light pipes.

20. The method of claim 18, further comprising the steps of:
deflecting light emitted from said first group of light pipes and said second group of light pipes through a series of convex radius of curvatures and concave radius of curvatures;
alternating said series of convex radius of curvatures and said series of concave radius of curvatures; and
connecting said series of convex radius of curvatures and said series of concave radius of curvatures by way of a series of interconnection points, forming a series of convex arcs and a series of concave arcs, thereby creating a segment of said lens having a plurality of segments.
